(19) United States
(12) Patent Application Publication
(10) Pub. No.: US 2010/0105243 A1
(43) Pub. Date: Apr. 29, 2010

(54) JUNCTION BLOCK AND LINK BAR

(75) Inventors: Michel Sartorio, Chassieu (FR); Geoffrey Moine, Ecully (FR)

Correspondence Address: CANTOR COLBURN, LLP, 20 Church Street, 22nd Floor, Hartford, CT, 06103, US

(73) Assignee: ABB FRANCE, RUEIL-MALMAISON (FR)

(21) Appl. No.: 12/529,844

(22) PCT Filed: Feb. 11, 2008
(86) PCT No.: PCT/FR2008/000169

§ 371 Date: Nov. 3, 2009

(30) Foreign Application Priority Data
Mar. 8, 2007 (FR) 0701692

(51) Int. Cl. H01R 31/08

(52) U.S. Cl. 439/507

(57) ABSTRACT

The invention relates to a junction block that comprises a housing for receiving a conducting linking rod (16). The linking rod (16) includes on at least one end surface (23) a retaining portion (25) having a shape at least partially complementary with a retaining portion (16) of the opposite wall defining the housing (17), the rod retaining portions and the wall of the housing being urged in abutment upon a movement of the rod end towards the outside of the housing (17).

### TECHNICAL FIELD OF THE INVENTION

The present invention relates to a link bar, and a junction box comprising such a link bar.

### BRIEF DESCRIPTION OF RELATED ART

As is known, for example from the document GB815478, a conductive link bar is used in a junction block to electrically link different components of the block.

In particular, the link bar is used to link one or more connection terminals.

In the particular case of screw-connection terminals, to make an electrical contact between a conductor inserted into the terminal, the stripped end of the conductor must be screw-fastened onto the bar or onto an intermediate conductive element in contact with the bar. At the end of the fastening operation, considerable torque may be applied by the fastening means, for example a screwdriver, to the link bar, via a fastening screw.

In these conditions, the bar, under the effect of this torque, may be driven to rotate and leave the recess designed to receive it provided in the insulating body of the junction block.

It is therefore best to provide means of retaining the bar in the recess of the insulating body of the junction block.

To this end, it is known to have hooks made of the same material as the insulating body of the junction block, designed to bear on the lateral face of the bar to secure the latter in the recess of the insulating body.

However, this system cannot withstand high torques. Furthermore, these hooks generate a bulk over the length of the bar, and make it necessary to use a bigger bar to be able to offer a gripping position for the hooks on the lateral face of the bar.

### BRIEF SUMMARY OF THE INVENTION

To this end, the subject of the present invention is a junction block comprising a recess designed to receive a conductive link bar,

characterized in that

the link bar has on at least one end face a retaining portion having a shape that at least partially complements a retaining portion of the wall delimiting the recess, situated opposite, the retaining portions of the bar and of the wall of the recess coming into abutment against a movement of the end of the bar towards the outside of the recess.

These arrangements provide a way of obtaining an improved retaining effect, because the retaining contact between the retaining portions is provided at the end of the bar, that is, at the furthest possible point away from the screwing rotation axis.

Furthermore, the retaining portion on the bar is located on an end face, so obtaining the retention of the bar does not mean having to increase the longitudinal dimensions of the bar.

Advantageously, the walls of the retaining portions are oriented parallel to the rotation axis of a screw of a connection terminal of the junction block.

This arrangement provides a way of limiting the slipping of the retaining portions relative to each other and of exerting the abutment force along an axis perpendicular to the rotation axis of the screw.

Advantageously, the bar comprises two retaining portions located on the two end or front faces of the bar facing two retaining portions of the wall delimiting the recess.

The symmetrical arrangement of the bar reinforces the retaining of the latter.

Advantageously, a retaining portion comprises a notch, the facing retaining portion having a protrusion designed to penetrate at least partially into the notch.

According to an embodiment, the notch has a polygonal profile.

According to another embodiment, the protrusion is of rounded or polygonal form.

Advantageously, the wall of the recess includes a protrusion, and an opening close to the protrusion, so as to enhance the elasticity of the wall.

Advantageously, the protrusion or the notch has an oblique face in the direction of insertion of the link bar into the recess and a straight face in the direction of removal of the bar from the recess.

These provisions facilitate the insertion of the bar into its recess, while ensuring the effectiveness of the retention.

According to an embodiment, the wall of the recess has a thickness that is substantially constant at the level of the retaining portion.

This arrangement enhances the elasticity of the wall and facilitates the insertion of the bar into the recess while avoiding an overthickness of the wall of the recess in the position of a protrusion.

In any case, the invention will be clearly understood from the following description, given with reference to the appended diagrammatic drawing, representing by way of nonlimiting example one embodiment of a device according to the invention.

### BRIEF DESCRIPTION OF THE DRAWING

FIG. 1 is a view of a first junction block according to the invention, seen perpendicularly to one of its lateral faces.

FIG. 2 is a detail view in transverse cross section of the junction block of FIG. 1.

FIG. 3 is a detail view in horizontal cross section of the junction block of FIG. 1.

FIG. 4 is a detail view in horizontal cross section of a second junction block according to the invention.

FIG. 5 is a detail view in horizontal cross section of a third junction block according to the invention.

FIG. 6 is a detail view in horizontal cross section of a fourth junction block according to the invention.

FIG. 7 is a detail view in horizontal cross section of a fifth junction block according to the invention.

### DETAILED DESCRIPTION OF THE INVENTION

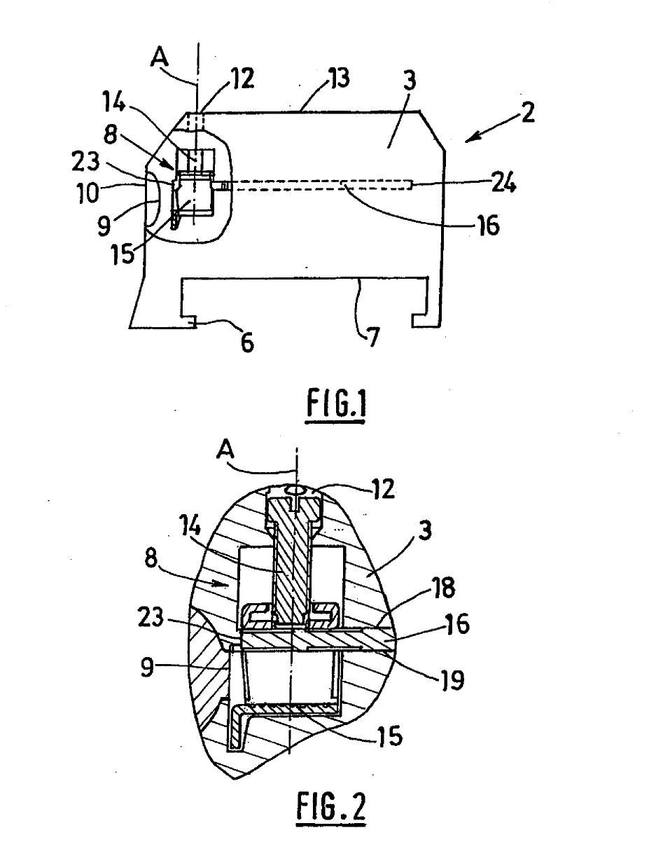

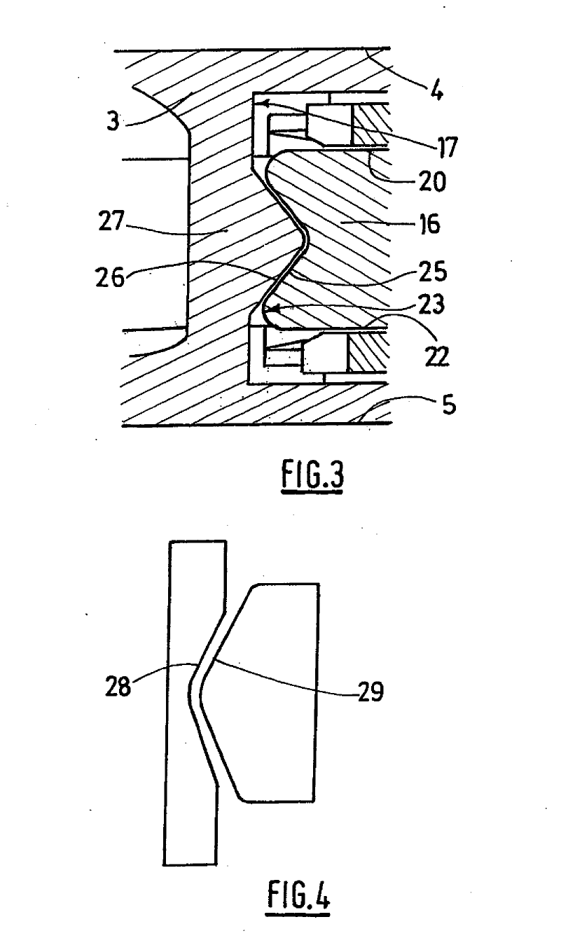

According to a first embodiment represented in FIGS. 1 to 3, a junction block 2 according to the invention has an insulating body 3 delimited by parallel lateral faces 4, 5, delimiting a thickness of the block that is less than the dimension of the lateral faces 4, 5. The junction block includes a fixing foot 6 designed to be fixed to a support rail, located on the rear face 7 of the block.

The junction block 2 also comprises two screw-connection terminals 8, each terminal 8 having an opening for inserting a conductor 9, located on one of the front faces 10 of the junction block, and an opening for inserting a tool 12, located on the face to the front 13 of the junction block, through which an operator can insert a tool of screwdriver type to fasten a fastening screw 14. Each terminal 8 is designed to ensure the connection between a conductor inserted through the conductor-insertion opening and a conductive link bar 16.

The contact between the conductor and the bar is provided by a clamp 15 driven by the screw 14 when the latter is driven rotation-wise by the screwdriver. The clamp 15 fastens the stripped end of the conductor against the bar 16.

The conductive link bar 16 is received in a recess 17 of the insulating body of the junction block, and oriented perpendicularly to the lateral faces 4, 5 of the body of the block 2.

The bar 16 is flattened, has a rectangular section, and therefore a top face 18 and a bottom face 19 that are parallel, and two parallel rear and front faces 20, 22.

The conductive bar 16 has, on each of its two end faces or front faces 23, 24 oriented parallel to the front faces of the block, a retaining portion 25 having a form that complements a retaining portion 26 provided on the wall 27 delimiting the facing recess, so that the bar 16 is retained inside the recess 17.

In this embodiment, the retaining portion 25 of the bar comprises a notch having a substantially triangular form, with two faces converging towards the bottom of the notch.

The portions of the wall 27 of the recess facing the retaining portions of the bar have retaining portions 26, in a protruding form, of substantially triangular form designed to penetrate at least partially into the notch 25.

The walls of the retaining portions 25, 26 are oriented parallel to the rotation axis A of a screw of a connection terminal 8 of the junction block 2.

According to a second embodiment represented in FIG. 4, the walls include triangular notches 28 and the bar has triangular protrusions 29.

According to a third embodiment represented in FIG. 5, similar to the first embodiment, the wall 30 has a thickness that is substantially constant level with the retaining portion, which means that a triangular hollow 32 is provided in the wall on the side opposite the protrusion for the elasticity of the insulating support on assembling the bar.

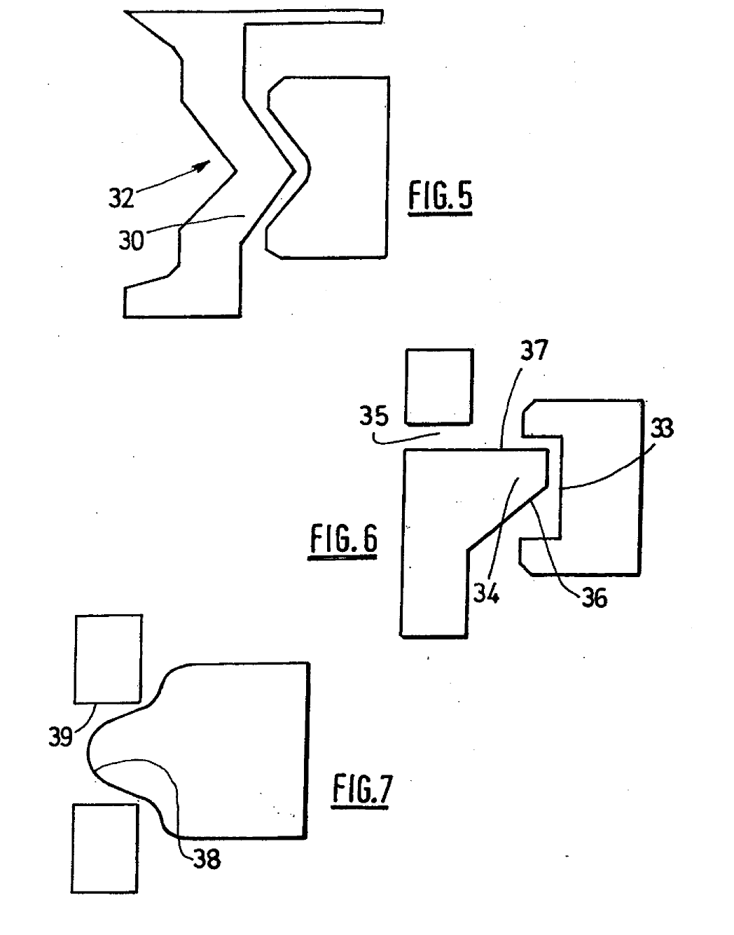

According to a fourth embodiment, represented in FIG. 6, the retaining portion 33 of the bar comprises a notch having a square profile.

The retaining portion of the wall of the recess includes a protrusion 34, and an opening 35 close to the protrusion, so as to enhance the elasticity of the wall.

The protrusion has an oblique face 36 in the direction of insertion of the bar into the recess and a straight face 37 in the direction of removal of the bar.

According to a fifth embodiment represented in FIG. 7, the retaining portion 38 of the bar comprises a protrusion of rounded form.

The retaining portion 39 of the wall of the recess includes a simple opening in the wall, designed to accommodate the protrusion.

Obviously, the invention is not limited to the preferred embodiment described hereinabove by way of nonlimiting example; on the contrary, it encompasses all the variants thereof.

1. A junction block comprising:
a recess designed to receive a conductive link bar,
wherein the link bar has on at least one end face a retaining portion having a shape that at least partially complements a retaining portion of a wall delimiting the recess, situated opposite, the retaining portions of the bar and of the wall of the recess coming into abutment against a movement of an end of the bar toward an outside of the recess.

2. The junction block as claimed in claim 1, wherein the walls of the retaining portions are oriented parallel to a rotation axis of a screw of a connection terminal of the junction block.

3. The junction block as claimed in one of claims 1, wherein the bar comprises two retaining portions located on the two end faces of the bar facing two retaining portions of the wall delimiting the recess.

4. The junction block as claimed in one of claims 1, wherein a retaining portion comprises a notch, the facing retaining portion having a protrusion designed to penetrate at least partially into the notch.

5. The junction block as claimed in claim 4, wherein the notch has a polygonal profile.

6. The junction block as claimed in claim 4, wherein the protrusion is of rounded or polygonal form.

7. The junction block as claimed in, wherein the wall of the recess includes a protrusion, and an opening close to the protrusion, so as to enhance elasticity of the wall.

8. The junction block as claimed in claims 4, wherein the protrusion or the notch has an oblique face in a direction of insertion of the link bar into the recess and a straight face in a direction of removal of the bar from the recess.

9. The junction block as claimed in claim 4, wherein the wall of the recess has a thickness that is substantially constant at a level of the retaining portion.
